(19) United States
(12) Patent Application Publication
(10) Pub. No.: US 2012/0083618 A1
(43) Pub. Date: Apr. 5, 2012

(54) METHOD OF IMPROVING OIL RECOVERY AND REDUCING THE BIOCHEMICAL OXYGEN DEMAND AND CHEMICAL OXYGEN DEMAND OF PALM OIL MILL EFFLUENT

(75) Inventors: Azlan Adnan, Singapore (SG); Darren Miles Bates, Queensland (AU); Michael P. Kennedy, Delano, MN (US); Alexander Patist, Shakopee, MN (US); Ian C. Purtle, Plymounth, MN (US)

(73) Assignee: CARGILL, INCORPORATED, Wayzata, MN (US)

(21) Appl. No.: 13/322,766

(22) PCT Filed: Apr. 16, 2010
(86) PCT No.: PCT/US10/31383

§ 371 Date: Nov. 28, 2011

Related U.S. Application Data
(63) Continuation of application No. 61/217,190, filed on May 28, 2009.

(51) Int. Cl. C11B 3/00

(52) U.S. Cl. 554/175

(57) ABSTRACT

Palm oil processing plants are continually looking for ways to improve oil recovery, and reduce bio-chemical oxygen demand and chemical oxygen demand of the palm oil mill effluent. A method is described for increasing the amount of oil recovered and reducing the bio-chemical oxygen demand and chemical oxygen demand of palm oil mill effluent by treating pressed palm oil slurry with ultrasonic energy prior to disposal of the effluent.

### CROSS REFERENCE TO RELATED APPLICATION

This application claims the benefit of the U.S. Provisional Patent Application, Ser. No. 61/217,190, filed 28 May 2009, entitled METHOD OF REDUCING THE BIOCHEMICAL OXYGEN DEMAND AND CHEMICAL OXYGEN DEMAND OF PALM OIL MILL EFFLUENT, which is hereby incorporated by reference in its entirety.

### FIELD

The field of art to which this invention pertains is organic compounds extracted from a plant source material utilizing water.

### BACKGROUND

The use of palm-oil in food preparation as well as personal care products such as soap and wound treatments has been around for well over a hundred years. While small, relatively primitive batch methods have historically been the main source of the oil production, it has evolved into larger scale continuous processing.

One of the problems facing this industry is the biochemical oxygen demand (BOD) and chemical oxygen demand (COD) of the waste products resulting from this processing, which is well known to be related to the amount of organic compounds in the water. In particular, the palm oil mill effluent generated during the extraction of the crude palm oil from palm fresh fruit bunches (FFB) contains large amounts of solid and liquid materials which can potentially cause pollution problems, including green house gas emissions, when they are disposed of into typical lagoons or waste water treatment ponds (WWTP)

Many attempts have been made to address this problem. This includes both mechanical treatments such as various filter systems and chemical treatments, for example, bacterial or enzymatic treatments. However, these treatments can be either quite complicated or expensive to carry out, or very time consuming, either or all of which can work against a successful operation of any commercial scale, especially in the remote locations where most of this processing takes place.

Accordingly, the present invention is specifically directed to an improved process for addressing the biochemical oxygen demand and chemical oxygen demand problems associated with the disposition of palm oil mill effluent.

### SUMMARY

The present invention is directed to a method of increasing oil recovery and reducing the biochemical oxygen demand and chemical oxygen demand of palm oil mill effluent. This is accomplished by treating the palm oil slurry with ultrasonic energy prior to disposal of the effluent. Ultrasonic energy levels of 10⁻⁵ to 10⁻¹ kilowatt hours per liter of effluent and flow rates of 60 to 80 liters per minute past the sonotrode used to generate the ultrasonic energy are also described. Typically, up to 60% of residual palm oil in the effluent is removed and recovered by the process.

### BRIEF DESCRIPTION OF THE DRAWINGS

FIG. 1 shows a flow chart for typical palm oil processing according to the present invention.

FIGS. 2, 3, and 4 show typical ultrasonic electrode configurations useful in the present invention.

FIG. 5 shows a typical continuous process for generating palm oil.

FIG. 6 shows an experimental palm oil processing set up demonstrating the present invention.

FIG. 7 shows experimental test results.

FIG. 8 shows test results for the use of several different sonotrodes.

FIG. 9 shows a sonotrodes-in-series version of the present invention.

FIG. 10 shows a sonotrodes-in-parallel version of the present invention.

### DETAILED DESCRIPTION

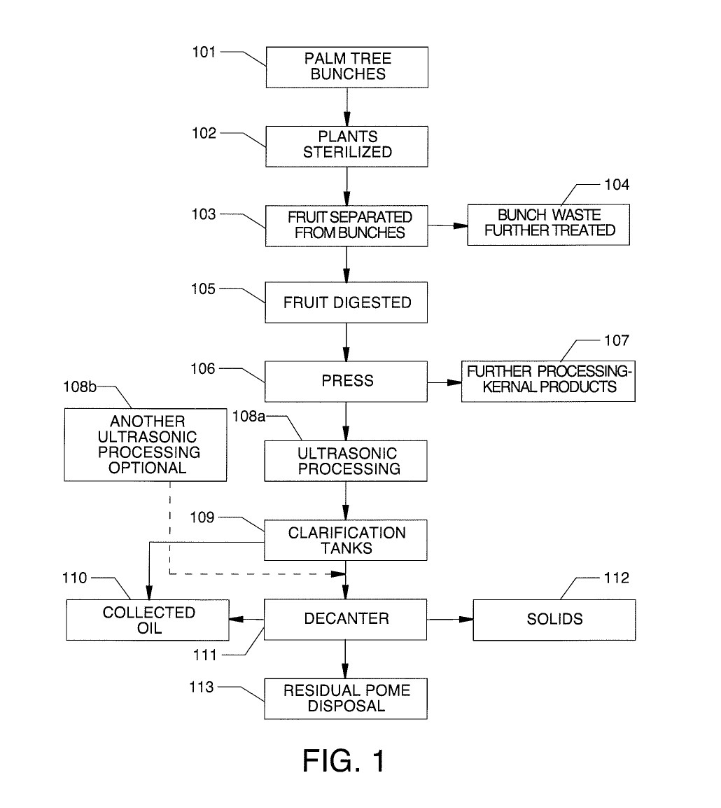

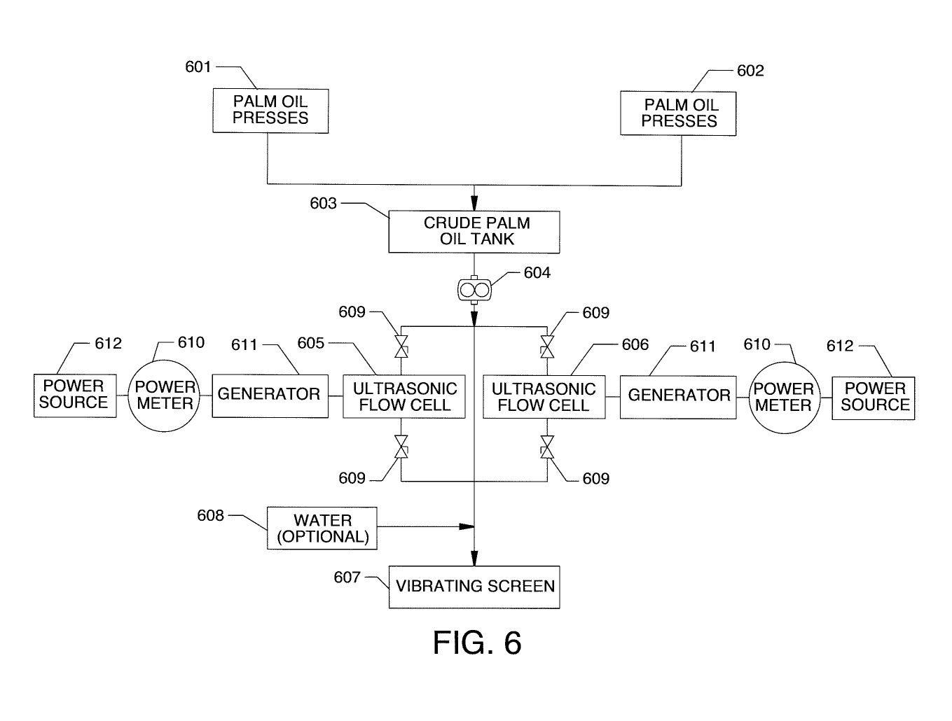

Referring to FIG. 1, with conventional palm oil processing, the FFBs are harvested from the oil palms and then are collected (101) and transported to the processing facilities. The FFBs are then sterilized (102), with low pressure steam, in order to inactivate the enzymes that promote the formation of free fatty acid, to loosen the fruit in the bunch to facilitate stripping or threshing process and to soften and condition the mesocarp to facilitate oil recovery and nut separation process. The fruitlets are then separated from the bunches, via mechanized threshers (103) in the threshing process. The empty bunches(104) are either transported as-is to the estates for mulching, or can be further processed into fibrous form as biomass fuel for boilers or can be incinerated to produce bunch ash. The next step in the process is digestion of the fruit (105)). This is typically accomplished in heated vessels containing stirring arms or beaters. This part of the process releases the largest portion of the palm oil entrained in the fruit. Following digestion of the fruit, the digested mass next flows to a screw press (106). Multiple presses can also be operated in parallel, emptying into a single container or holding tank (see, for example, FIG. 6, (603)). The press basically squeezes the palm oil out of the digested mass. The solid portion resulting from the pressing process also contains the nut of the palm fruit. This is subjected to further processing (107) which results in kernel as a final product.

The liquid portion resulting from the press process, generally referred to as the oil portion, in addition to containing substantial amounts of palm oil, also contains some amounts of water (typically having been added to increase the efficiency of the pressing process), cell debris, fibrous material and other non-oil solids. It is this fluid material resulting from the pressing process which is subjected to the ultrasonic processing (108a), resulting in reduced biochemical oxygen demand (BOD) and chemical oxygen demand (COD) of the palm oil mill effluent (POME). BOD and COD are basically a measure of the materials in water which can be oxidized. These measures were fostered to help measure the amount of pollution in a body of water. See Chemistry for Environmental Engineering and Science (5^{th} Edition), Sawyer et al (2003), the disclosure of which is incorporated by reference.

Following the ultrasonic treatment, the pressed palm oil is sent to clarification tanks (109) to further separate the oil from sludge phase. At this point the clarified palm oil is purified (110) and sent through a vacuum dryer (111) and collected (112) and the sludge phase is further processed in a 3-phase decanter (113). The decanter separates the palm oil into oil phase (termed as light phase) which is further collected (114) and recycled back to the clarifier tank, and decanter cake or solids (115) which are generally used as fertilizer in the estates, and the residual heavy phase residual POME which is disposed of (116), e.g., into WWTP (waste water treatment ponds). Optionally, this is another point (also shown as 108b) where the ultrasonic treatment of the present invention can be used, e.g. before the decanter, to further reduce BOD and COD in the POME.

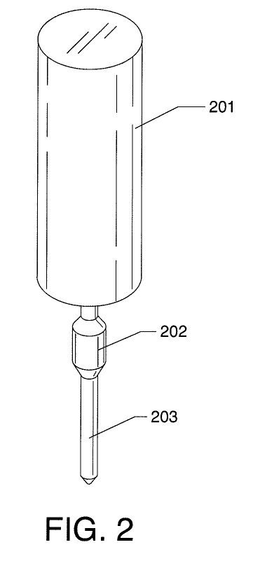

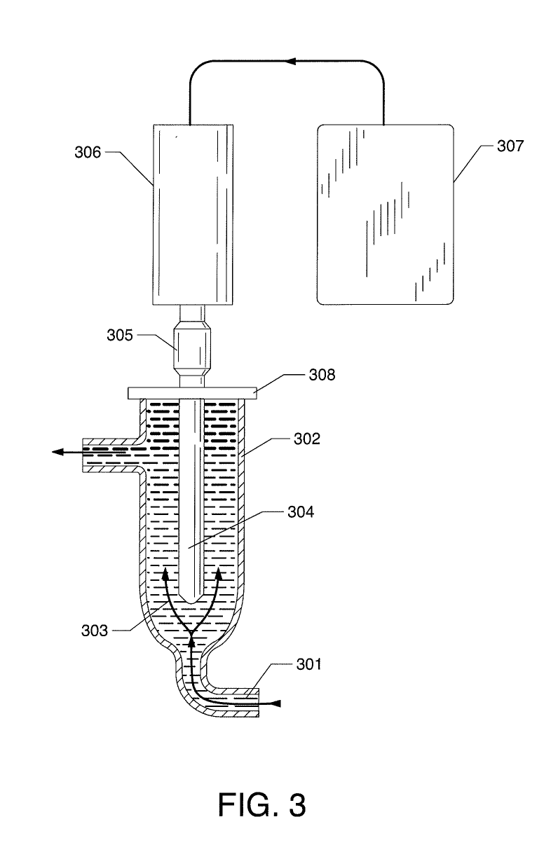

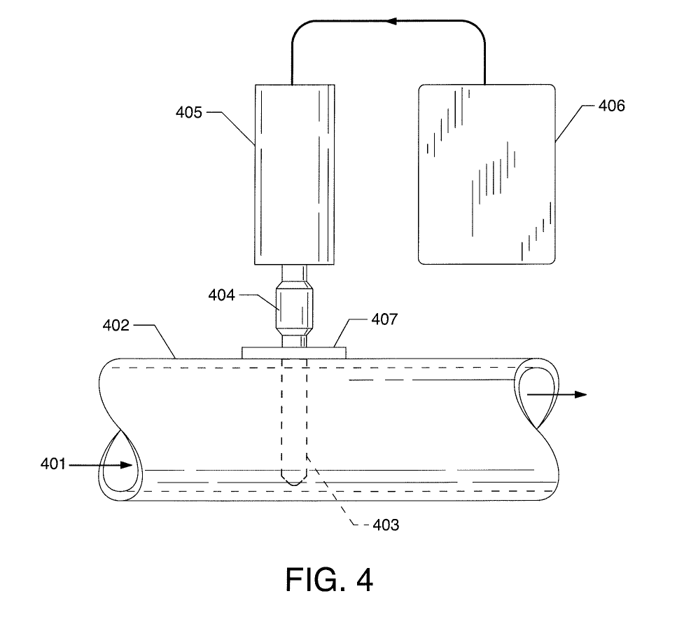

While there are many commercially available sonotrode-transducer arrangements which can be used to subject the effluent material to the ultrasonic energy (FIG. 2), typically the transducer (201) is connected to a booster (202) and a sonotrode (203). The sonotrode can be of the radial type as shown in FIG. 2 with a conical tip, or of the focused type (not shown), with a flattened tip. The boosters are conical and tapered, and are also commercially available. They assist in controlling (boosting up or down) the energy going into the sonotrodes. The fluid to be treated is typically passed by the sonotrode directly for ultrasonic treatment. However, other arrangements can be used as well, e.g., any flow through arrangement which insures that the effluent material is contacted with the ultrasonic vibrations generated from the transducer-sonatrode combination to rupture the cell material. (See, for example, FIGS. 3 and 4).

In FIG. 3, the effluent to be treated (301) is flowed into a cylindrical container or channel (302) with internal passageways (303) which forces the effluent into contact with the radial probe (sonotrode) (304) connected to a booster (305) (to increase or decrease the energy level or amplitude). The transducer (306) (e.g., piezo ceramic) is connected to a conventional power source (307) (e.g., 220 volt AC generator). A conventional anti-vibrational flange (308) is also shown here.

In FIG. 4, the effluent to be treated (401) is flowed through a cylindrical container or channel (402) past the sonotrode (403) connected to a booster (404). The transducer (405) is connected to a power source (406). A conventional, commercially available, anti-vibrational flange (407) is also shown here.

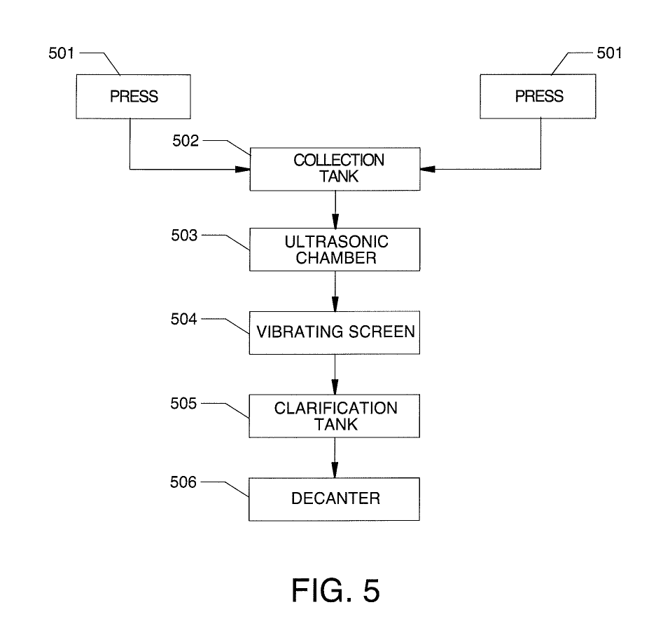

While the process can be run in a batch process as shown, for example, in FIG. 1, it is preferred to run it in a continuous process as shown, for example, in FIG. 5. In FIG. 5, multiple presses (501) squeeze the palm oil out of the digested mass (as described above with reference to FIG. 1). The oil containing fluid is then (optionally collected in a collection tank (502) and) flowed through the ultrasonic chamber (503) containing a probe connected to the transducer-sonotrode combination such as shown in FIG. 2, for example, to further rupture the palm oil containing cells, releasing additional oil, and also releasing additional oil from cell debris, fibrous material and other non-oil solids (other carbon containing materials in the effluent stream could potentially also be broken down in the process, further reducing potential pollutants in the effluent stream). The treated fluid then passes through vibrating screens (504). The remainder of the process is similar to that described in FIG. 1, including passage into clarification tanks (505), a series of decanters (506), purifier (507), vacuum dryer (508) and crude palm oil storage (509). In a continuous process, typically multiple presses are run at the same time and the effluent flow is channeled past the sonotrodes accordingly (FIG. 6). For example, in a four press system, up to three presses can be operated simultaneously while the fourth press is worked on off-line, and the other presses similarly rotated in and out of service for maintenance purpose. In this type of system, the flow rate of the effluent past the sonotrodes is typically about 60 to 80 liters per minute, and preferably 75 liters per minute. At this rate of flow, up to 60% of the palm oil retained in the effluent is removed, and preferably about 45% to 55% removed.

The ultrasonic apparatus (transducers, sonotrodes or probes, and boosters) useful in the present invention are all commercially available, and comprise a conventional transducer and appropriate boosters and ultrasonic probes or sonotrodes. Transducers useful with the present invention typically have power ranges up to 1000 Watts per cubic centimeter. A transducer transforms electrical energy into vibrational (oscillatory) energy. The ultrasound emitting surface area is the surface area where ultrasonic energy is emitted into the fluid mixture, e.g., through the sonotrode (203) surface (FIG. 2). The amplitude of the waves produced is the magnitude of the maximum disturbance in the fluid during one wave cycle of an ultrasound wave. Specific energy refers to the energy consumed by the ultrasonic system, and the average specific energy in this context means the total specific energy applied to the fluid divided by the total volume of the fluid (in liters).

As mentioned above, the apparatus for generating the ultrasonic energy within the fluid system are commercially available from a variety of sources. Such systems generally include a transducer, which is the source of the vibrational energy. These transducers are available in discrete power units, e.g. 1 kilowatt (kW), 1.5 kW, 2 kW, 4 kW, 8 kW, 16 kW, etc., which can be used as a single unit, or as a combination of units. It is possible to use a whole series of transducers within one ultrasonic system, each of them providing ultrasonic energy at its specific power, either in series, or in parallel. Typical power ranges for transducers used in the present invention are in the range between 0.01 and 40 kW, and more typically in the range between 1 kW and 16 kW.

There are also multiple ways for how an ultrasonic system suitable for use with the present invention can be setup. The typical ultrasonic system contains a generator or other power source (307), and a transducer (306)—sonotrode (304) combination as illustrated in FIG. 3. The sonatrode is typically inserted into a fluid flow cell (302). As the fluid mixture passes the sonotrode, the ultrasonic energy is absorbed by the fluid mixture.

Ultrasonic systems generally utilize a probe, a so-called sonotrode, for transmitting ultrasonic energy into the reaction mixture. The types of sonotrodes used can also vary, e.g., axial or focused probes (with a flat tip) and radial probes (typically cylindrical with a conical tip of decreasing diameter, typically at a 90 degree angle), each of which is suitable for the methods described herein. Since the radial probes emit ultrasonic energy from all sides, as opposed to the focused or axial probe, in most cases, at least from an energy use perspective, it would be the preferred choice. The sonotrodes are typically classified as long radial (e.g., 410 mm long), medium radial (e.g., 285 mm long), and axial (e.g., 125 mm in length). A typical diameter for such probes is approximately 34 mm.

Generally, there are three ways to transmit ultrasonic energy into a mixture:
(1) a sonotrode can be directly in touch with the mixture and transfer ultrasonic energy directly into the mixture via the sonotrode (or probe) surface which is in direct contact with the fluid being processed (FIG. 3), or
(2) indirectly via one or more transducers attached to the outside of a flow cell or tube (made of steel, plastic or other vibration conducting material) making the tube ultrasonically active. The transducers can be welded to the flow cell, or screwed into the flow cell via a thread connection, connected by strap, or otherwise connected to the flow cell, or
(3) the ultrasonic energy can be transferred indirectly via a suitable medium (water, oil, or other organic or inorganic fluid) through the walls of the flow cell and into the medium being processed.

The ultrasonic energy emitted per square centimeter (cm²) from at least one of the ultrasound emitting surface areas (e.g., probe or sonotrode) is typically in the range from 0.001 watts (W)/cm² to 1000 W/cm², and more typically from 0.5 to 10 W/cm², using two sonotrode-transducer combinations in parallel. The ultrasonic energy typically has a wave with an amplitude in the range of 1 micrometer to 1000 micrometer, more typically 5 to 500 micrometers, and most typically 5 to 150 micrometers.

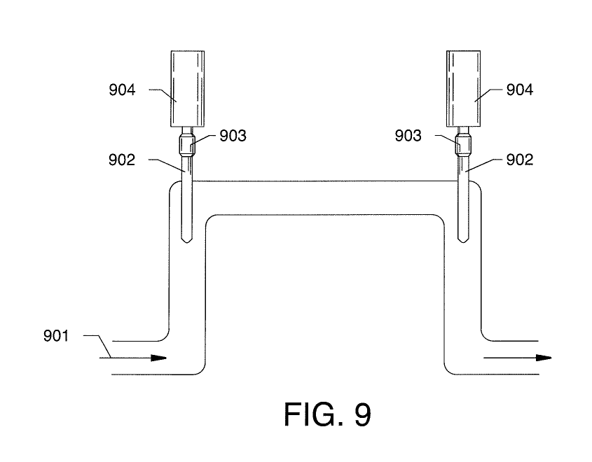

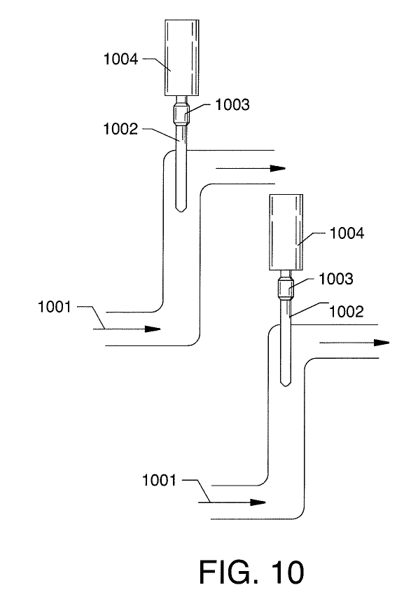

The ultrasonic energy is typically applied to the reaction mixture at an average specific energy (kilowatt hours (kWh) per liter of effluent material) of between 1×10⁻⁵ kWh and 1×10⁻¹ kWh of ultrasonic energy per liter of effluent, and more typically between 1×10⁻⁴ kWh and 1×10⁻² kWh of ultrasonic energy per liter of effluent, with a flow rate of 60 to 80 liters per minutes past each of the two (or more) parallel sonotrode-transducer combinations (total flow rate typically about 150 liters per minute from all presses in a continuous process). It should also be noted that while a sonotrode-transducer parallel arrangement is preferred (see FIG. 10, where the effluent (1001) flows by the sonotrode (1002), booster (1003), transducer (1004) combination in parallel), the sonotrode-transducer combinations can be run in series as well—see, for example, FIG. 9, where the effluent (901) flows by the sonotrode (902), booster (903), transducer (904) combination in series.

The emitted ultrasonic energy also typically has a frequency of more than 15 kilohertz (kHz), more typically from 15 to 500 kHz, and most typically from 16 to 24 kHz. The ultrasonic energy density per volume of effluent is also typically in the range from 0.001 Watt (W)/cm³ to 1000 W/cm³, more typically in the range from 1 W/cm³ to 500 W/cm³, and most typically in the range from 1 W/cm³ to 200 W/cm³.

As mentioned above, it is believed that one aspect of the improved BOD and COD performance of the POME is attributable, in large part, to the increased disruption of the palm oil cells resulting in more palm oil being recovered from the fruit and less being released into the holding ponds. The total amount of oil released (e.g., freed oil from emulsion phase, and intact oil from cells) can be as high as 5% on a dry basis of solids going into the ponds. Test tube sampling showed a 16% increase in oil recovery, and other samples showed a 10% increase in oil recovered from the treated samples (by volume). In addition, the cellular breakdown was achieved without forming an emulsion. In the overall process, all of this translates into up to a 16% increase in oil recovery by volume, which in addition to improved POME going into the ponds, can result in millions of dollars of increased revenue from conventional processing.

### EXAMPLE 1

An un-diluted palm oil slurry (containing—by volume—40% sludge solids and 60% oil) and a diluted palm oil slurry (containing oil=38%, emulsion=6%, water 26%, sludge solids 30%) were treated with ultrasonic energy. A commercially available 400 Watt laboratory ultrasonic unit with a 40 mm diameter axial probe was used to conduct tests on 1000 ml samples of palm oil slurry at different amplitudes of 100% setting (15 micron displacement) and 20% setting (3 micron displacement). Treatment time was 15 seconds for all tests. Characterization of oil cell breakdown and emulsification was achieved by microscopy. Oil extraction yield was determined by settling tests over a period of 1 hour (90° C.) as well as centrifugation using a conventional lab centrifuge (3 min. standard spin test). After centrifugation the volume of the decanted oil was recorded. The results for the undiluted palm oil slurry were as follows: both low amplitude and high amplitude treatments showed clear breakdown of cellular material. No evidence of emulsification was observed after both ultrasonic treatments (using microscopic examination). In order to replicate the settling/separation tank in a plant process, one hundred (100) ml samples of the treated and un-treated material were placed in glass beakers and placed in a heated water bath (90° C.) for a period of 1 hour to allow the oil and sludge to separate to determine if more oil was released from the cellular material following the ultrasonic treatment. Based on a side-by-side comparison of the beakers (control, low amplitude and high amplitude treated samples), about 10% by volume more oil was recovered in the treated samples, without any emulsification effects. There was little difference between the low and high ultrasonic energy tests, which is very beneficial from an economic, capital cost and energy perspective. After 1 hour of settling at 90° C., the slurry samples were centrifuged and the oil decanted off The un-treated (control) sample produced 54 ml of oil whereas the ultrasonic treated sample at low amplitude produced 72 ml oil. This result suggests the potential for a significant decrease in oil presence in the effluent as well as an enhancement in oil yield. Samples of the diluted material described above were similarly treated with low amplitude and high amplitude ultrasound for 15 seconds. The low amplitude sample showed no evidence of emulsification but did indicate cell breakdown. Higher amplitude ultrasound indicated a small amount of emulsification, however, the emulsion component split and separated after a period of 30 minutes. Samples were tested using a typical, standard laboratory centrifuge. The two samples of centrifuged diluted palm oil showed only a small difference in oil. The un-treated sample produced 37 ml of oil whereas the ultrasonic treated sample at low amplitude produced 43 ml (oil was again decanted from a 100 ml slurry sample which had been centrifuged). This result (+16% oil), although not as big as the un-diluted material (+33%), still demonstrates potential for oil reduction in the effluent and enhancement in overall oil yield for the process. These results also show that low amplitude ultrasound can break down cellular material and release more palm oil in the process stream. When separated from the palm oil mill effluent, this will result in lower BOD and COD. The results also indicate the potential to achieve cellular breakdown without forming an emulsion. Based on these lab results, this technique also has the following benefits to the palm oil process: increased oil recovery, no emulsion formation, low amplitude and power requirements, leading to lower operating costs.

### EXAMPLE 2

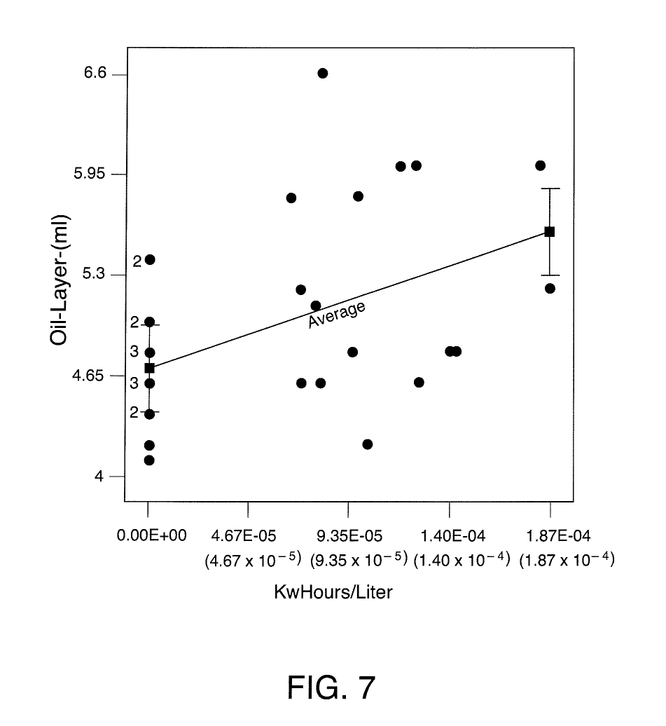

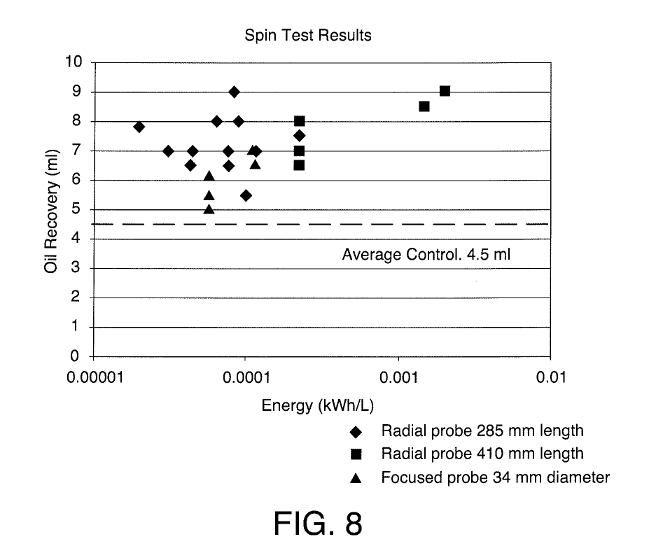

The crude oil coming from 2 conventional palm oil presses (shown as 601 and 602 in FIG. 6) was combined undiluted in a 2 m³ crude oil tank (603). A gear pump (604) sent the flow exiting this tank into two separate, parallel ultrasonic flow cells (605 and 606). The oil exiting the ultrasonic flow cells were combined again just on top of a conventional vibrating screen (607). Water can be added and turned on and off just above this screen (608). Valves (609) located before and after the ultrasonic flow cells allowed for flow rate and back pressure control. A total of 28 pilot runs were performed varying flow rate, power and probe type utilizing two 1 kW systems. The flow rate was determined using a 20 litre bucket and stopwatch. The power was read from a power meter (610) connecting the generator (611) to the power source (612) (e.g., 220V outlet). Oil extraction yield was determined by settling tests over a period of 1 and 4 hours at 90° C. as well as centrifugation using a lab centrifuge (10 ml sample, 3 min. standard spin test). After centrifugation (spin) the volume of the decanted oil was recorded. In FIG. 7, the total volume of oil in ml (reflecting the oil percentage divided by 10) after centrifugation of the undiluted oil sample shows the spin test results for all of the pilot runs (at 750 to 850 watts per unit for two units). The flow rate (5 to 120 liters per minute) and power (100 to 800 watts) ratio were plotted as kilowatt hours per liter (kWh/L) vs. oil yield. Note that a control was taken every time a sample was taken (shown on the left side of the graph). The straight line represents the average calculation of the results, going from a value of 4.65 ml up to 5.6 ml. In separate testing, with an average control of 4.5 ml (compared to an average of a typical processing plant of 4.4 ml.), the impact of using radial probes of different lengths versus a focused probe were also compared. The results for the medium radial probe (285 mm in length, 34 mm in diameter) are shown in FIG. 8 as diamonds, the results for a second long radial probe (410 mm in length, 34 mm in diameter) are shown as squares, and the results for a focused or axial probe (125 mm in length, 34 mm in diameter) are shown as triangles. The results show that both radial probes performed well. The focused probe did not perform as well. It was also found that an average energy of 1×10⁻⁴ kWh/L was sufficient to break up the cells. Several samples were taken and placed on a hot plate (90° C.) for 1 and 4 hours to evaluate settling performance. Due to a limited number of hot plates available in the lab, only a few tests were performed, basically to confirm the spin test results. Again, in all cases the volume of clear oil on top of the beaker was larger for the sonicated samples. Based on the results of the feasibility tests, 2×1 kW systems to treat 150 L/min, which corresponds to one press (20 metric tons per hour (mt/hr) feed=8 mt/hr cake=9 m³/hr oil=150 L/min) would appear to work well. While larger single ultrasound transducers are available (2, 4, 10 and even 16 kW), the environment in which the plant operates (humid, hot, steamy) would suggest using smaller systems, which also have the advantage of using transducers that do not require oil or water cooling. The addition of the ultrasound showed greater oil recovery over the control for every pilot test conducted (28 in total) and greater oil recovery over the control in settling rate tests both after 1 and 4 hrs. The energy input (in kWh/L) for improving oil recovery is also quite low (e.g., 1×10⁻⁴ kWh/L). Increasing the energy resulted only in small improvement in recovery. Radial sonotrode, 285 mm length, on average showed better results (energy input wise) than the two other probes tested. Test results also seem to indicate that the process is not amplitude dependent. It is also clear that no back pressure is necessary (e.g., line pressure is sufficient for coupling). Based on the data from this pilot trial, 2×1 kW systems are sufficient for a flow rate of 150 L/min (=20 mt/hr press).

### EXAMPLE 3

Ultrasonic Power vs. Oil Recovery: An important part of feasibility and development is the determination of the minimum power (or maximum flow rate) to maximize the impact of the introduction of the ultrasonic treatment. This is the ultrasonic energy (average specific energy, W_{spec}) input and is expressed in kWh/L (kilowatt hours per liter)(W=watts; Q=flow rate; kW=kilowatts):

$${W}_{input} ( kWh \text{/} L ) = {W}_{spec} = \frac{Power . of . Sonotrode . ( W )}{Q . ( L \text{/} min ) \times 60. ( min \text{/} hr ) \times 1000. ( W \text{/} kW )}$$

A set of experiments was carried out where the flow rate was kept constant as much as possible (65-75 L/min) and the power on the sonotrode varied between 300 and 750 Watts. Samples were taken before and directly after the probe and sent to the lab for oil analysis. The results are shown in FIG. 7. The results confirm earlier data that power is directly related to oil elimination. Therefore it is recommended to run the ultrasonics as close to its maximum output as possible, preferably 850 to 900 Watts to allow for upswings (systems will typically automatically shut off at 1000 Watts). Accordingly, the amount of ultrasonic energy applied to the effluent is typically in the range of about 1×10⁻⁵ to about 1×10⁻¹ kilowatt hours of energy per liter of palm oil mill effluent, and preferably about 1×10⁻⁴ to about 1×10⁻² kilowatt hours of energy per liter of palm oil mill effluent.

### EXAMPLE 4

Mass balance: The decanter operates at a constant feed rate of 22 metric tons (mt)/hr and is pumped straight out of the sludge tank. The sludge tank was filled with sludge from the conventional process and ultrasonic (U/S) process separately for this experiment. A total of 3 ultrasonic tests were performed. The flow rates and results of the spin test (in weight %) are shown in the Table. It is clear that the residual oil in the ultrasonically treated sludge is consistently lower than the conventional non-treated sludge.

TABLE
Oil composition and flow rates exiting the decanter

| | Decanter Flows | | | | | | |
|---|---|---|---|---|---|---|---|
| | POME | % Oil | POME Oil | Solids | % Oil | Solids | Total Oil |
| | Flow | In | Loss | Flow | In | Oil | Loss |
| Test | Mt/hr | POME | Mt/hr | Mt/hr | Solids | Loss Mt/hr | Mt/hr |
| Conventional | 20.33 | 1.34 | 0.272 | 0.94 | 3.91 | 0.0309 | 0.303 |
| U/S Avg | 19.31 | 0.73 | 0.141 | 0.91 | 3.27 | 0.03 | 0.171 |
| U/S 1 | 19.84 | 0.66 | 0.129 | 0.9 | 3.14 | 0.028 | 0.157 |
| U/S 2 | 18.38 | 0.67 | 0.122 | 0.85 | 2.92 | 0.025 | 0.147 |
| U/S 3 | 19.72 | 0.87 | 0.172 | 0.97 | 3.74 | 0.036 | 0.208 |

The following conclusions can be drawn from this experiment: samples taken directly before and after the ultrasonic flow cell show a statistically significant increase of 5% oil in the top layer of the spin test. The data also shows that the two ultrasonic systems behave the same (same improvement). Ultrasonic power is directly related to the oil recovery. Therefore, it is recommended to run the ultrasonics as close to its maximum (1 kW each) as possible. Current design recommends 2×1 kW per (20 mt/hr) press, total 150 L/min (75 L/min per ultrasound unit, although it can be as low as 60 L/min). Mass balance over the decanter was calculated determining the reduced losses in POME and solids. Based on the flow rate and concentration of oil in solids and the POME exiting the decanter, the ultrasonic process showed 45% less oil in the POME compared to the conventional process.

1. A method of increasing oil recovery and reducing the biochemical oxygen demand and chemical oxygen demand of palm oil mill effluent comprising reducing the amount of palm oil in the effluent by treating the palm oil mill effluent prior to disposal with ultrasonic energy.

2. The method of claim 1, wherein the amount of ultrasonic energy applied to the effluent is 1×10⁻⁵ to 1×10⁻¹ kilowatt hours of energy per liter of palm oil mill effluent.

3. The method of claim 1, wherein the amount of ultrasonic energy applied to the effluent is 1×10⁻⁴ to 1×10⁻² kilowatt hours of energy per liter of palm oil mill effluent.

4. The method of claim 1, wherein the ultrasonic energy is provided by at least one sonotrode-transducer combination.

5. The method of claim 4 wherein multiple sonotrode-transducer combinations are run in parallel.

6. The method of claim 4 wherein multiple sonotrode-transducer combinations are run in series.

7. The method of claim 4, wherein the palm oil mill effluent is treated at a flow rate of 60 to 80 liters per minute.

8. The method of claim 7 wherein the palm oil mill effluent is treated at a flow rate of 75 liters per minute.

9. The method of claim 1 wherein the amount of palm oil in the palm oil mill effluent is reduced by up to 60% by volume.

10. The method of claim 9 wherein the amount of palm oil in the palm oil mill effluent is reduced by 45% to 55% by volume.

11. The method of claim 1 wherein the oil recovery is increased by up to 16% by volume.

12. The method of claim 1 wherein the oil recovery is increased by 10% to 16% by volume.

13. The method of claim 5, wherein the palm oil mill effluent is treated at a flow rate of 60 to 80 liters per minute.

14. The method of claim 6, wherein the palm oil mill effluent is treated at a flow rate of 60 to 80 liters per minute.
